(19) United States
(12) Patent Application Publication
(10) Pub. No.: US 2016/0370632 A1
(43) Pub. Date: Dec. 22, 2016

(54) DISPLAY PANEL AND TOUCH DISPLAY DEVICE COMPRISING THE SAME

(71) Applicant: InnoLux Corporation, Miao-Li County (TW)

(72) Inventors: Hui-Min HUANG, Miao-Li County (TW); Chengtso CHEN, Miao-Li County (TW); Li-Wei SUNG, Miao-Li County (TW)

(21) Appl. No.: 15/162,860

(22) Filed: May 24, 2016

(30) Foreign Application Priority Data
Jun. 19, 2015 (CN) 201510344500.1

(51) Int. Cl. G02F 1/1339; G02F 1/1333; G02F 1/1362

(52) U.S. Cl. CPC G02F 1/13394; G02F 1/136286; G02F 1/13338; G02F 2001/13396

(57) ABSTRACT

A display panel is disclosed, which comprises: a first substrate with scan lines and data lines disposed thereon, wherein the scan lines are substantially disposed in parallel, the data lines are substantially disposed in parallel, the scan lines and the data lines intersect with each other and form intersections, and the intersections comprise first overlapping regions and second overlapping regions; main spacers correspondingly disposed on part of the first overlapping regions, wherein each of the part of the first overlapping regions forms a first vector to each of the main spacers; and sub-spacers correspondingly disposed on part of the second overlapping regions, wherein each of the part of the second overlapping regions forms a second vector to each of the sub-spacers; wherein at least two of the first vectors are different, and at least two of the second vectors are different.

### CROSS REFERENCE TO RELATED APPLICATION

This application claims the benefits of the China Patent Application Serial Number 201510344500.1, filed on Jun. 19, 2015, the subject matter of which is incorporated herein by reference.

### BACKGROUND OF THE INVENTION

1. Field of the Invention

The present invention relates to a display panel and a touch display device comprising the same. In particular, an example embodiment of the present invention relates to a display panel and a touch display device with improved ripple effect by adjusting positions of main spacers and/or sub-spacers.

2. Description of Related Art

As display technology advances, all devices are now being developed in smaller sizes with thinner thicknesses and lighter weights. Thus, the mainstream display device in the market has changed from the previous cathode ray tube to liquid crystal display device. There are many applications for liquid crystal display device used in daily life such as mobile phones, laptop computers, video cameras, cameras, music players, mobile navigation devices, and televisions. Most of these display devices use liquid crystal display panel.

In general, a liquid crystal display panel is manufactured by disposing liquid crystal molecules onto a substrate followed by correspondingly assembling an upper and a lower substrate. When the space between the upper and the lower substrate is larger than the predetermined space, bubbles will form in a liquid crystal layer. When the space between the upper and the lower substrate is smaller than the predetermined space, the liquid crystal molecules in the liquid crystal layer will be uneven and cause mura. Hence, currently, process window for liquid crystal injection is provided by forming main spacers and sub-spacers with different heights.

When a touch panel is disposed on the upper substrate of a liquid crystal display panel, touching the panel will result in ripple effect if the liquid crystal display panel is not hard enough or the module strength is insufficient. When an alignment of the main spacer or the sub-spacer is inaccurate, the space between the upper substrate and the lower substrate will differ from the predetermined space. When the height difference of the liquid crystal layer increases after the upper substrate and the lower substrate are correspondingly assembled, touching the panel will result in ripple effect in the liquid crystal layer.

Therefore, there is a need to develop a display panel with improved ripple effect caused by touching the panel.

### SUMMARY OF THE INVENTION

An embodiment of the present invention relates to a display panel. By adjusting the relative positions of main spacers and/or sub-spacers to overlapping regions of scan lines and data lines of the display panel, ripple effect caused by touching the display panel could be reduced.

An embodiment of a display panel of the present invention comprises: a first substrate with a plurality of scan lines and a plurality of data lines disposed thereon, wherein the scan lines are substantially disposed in parallel, the data lines are substantially disposed in parallel, the scan lines and the data lines intersect with each other and form a plurality of intersections, and the plurality of intersections comprise a plurality of first overlapping regions and a plurality of second overlapping regions; a plurality of main spacers correspondingly disposed on part of the first overlapping regions, wherein each of the part of the first overlapping regions forms a first vector to each of the plurality of main spacers; and a plurality of sub-spacers correspondingly disposed on part of the second overlapping regions, wherein each of the part of the second overlapping regions forms a second vector to each of the plurality of sub-spacers; wherein at least two of the first vectors are different, and at least two of the second vectors are different.

In an embodiment of the display panel of the present invention, each of the part of the first overlapping regions forms a third vector to each of the closest main spacer, each of the part of the second overlapping regions forms a fourth vector to each of the closest sub-spacer, and at least two of the third vectors are different and at least two of the fourth vectors are different.

In an embodiment of the display panel of the present invention, a height of the main spacers is greater than a height of the sub-spacers. A difference between heights of the main spacers and the sub-spacers is preferably 0.01 μm to 4 μm.

In an embodiment of the display panel of the present invention, when at least two of the first vectors are different, the main spacers comprise a first main spacer and a second main spacer, wherein the first main spacer overlaps with the first overlapping region, and the second main spacer is at a distance from the first overlapping region that the second main spacer is correspondingly disposed. When at least two of the second vectors are different, the sub-spacers comprise a first sub-spacer and a second sub-spacer, wherein the first sub-spacer overlaps with the second overlapping region, and the second sub-spacer is at a distance from the second overlapping region that the second sub-spacer is correspondingly disposed.

In an embodiment of the present invention, the display panel provided is a liquid crystal display panel and the liquid crystal display panel further comprises a second substrate and a liquid crystal layer, wherein the liquid crystal layer is disposed between the first substrate and the second substrate.

In an embodiment of the present invention, the main spacers and the sub-spacers are respectively disposed on the first substrate or the second substrate. Preferably, the main spacers and the sub-spacers are both disposed on the first substrate or the second substrate. More preferably, the main spacers and the sub-spacers are both disposed on the second substrate.

In addition to the display panel described above, an embodiment of the present invention also provides a touch display device comprising: a display panel described above; and a touch panel disposed on the display panel.

In an embodiment of the present invention, the main spacers and the sub-spacers may be manufactured by different processes. In this case, if an alignment of the main spacers or the sub-spacers is inaccurate, the space between an upper substrate and a lower substrate will differ from the predetermined space. Accordingly, in the present invention, by adjusting the relative positions of the main spacers and/or the sub-spacers to the overlapping regions of the scan lines and the data lines (the first overlapping regions and/or the second overlapping regions), the deviation caused by an inaccurate alignment of the main spacers or the sub-spacers can be compensated. In other words, by adjusting vectors of the main spacers and/or the sub-spacers from the correspondingly disposed first overlapping regions and/or the second overlapping regions, the deviation caused by the inaccurate alignment of the main spacers or the sub-spacers can be compensated. Consequently, even when the alignments between the main spacers or between the sub-spacers are inaccurate, the space between the upper substrate and the lower substrate is still the same as the predetermined space. Subsequently, the ripple effect that occurs by touching the liquid crystal display panel can then be reduced.

In addition, an embodiment of the display panel of the present invention may further comprise a pixel electrode. The pixel electrode is electrically connected to the data line through a contact via. The contact via is disposed outside the overlapping region of the scan line and the data line (outside the first overlapping region and/or the second overlapping region). In other words, no contact via is disposed on the overlapping region of the scan line and the data line (the first overlapping region and/or the second overlapping region). The disposed positions of the main spacers and the sub-spacers are different from the disposed positions of the contact vias. When the disposed positions of the main spacers and the sub-spacers are overlapped with the disposed positions of the contact vias, the height difference between the main spacers and the oppositely-disposed substrate and between the sub-spacers and the oppositely-disposed substrate will increase. As a result, the amount of liquid crystals will increase at this position and the ripple effect occurs more easily by touching the display panel. Accordingly, in the present invention, by not overlapping the disposed positions of the contact vias and the disposed positions of the main spacers and the sub-spacers, the problem described above can be solved.

Other objects, advantages, and novel features of the present invention will become more apparent from the following detailed description when taken in conjunction with the accompanying drawings.

### BRIEF DESCRIPTION OF THE DRAWINGS

FIG. 1 is a cross-sectional view of a liquid crystal display panel of the present invention;

FIG. 2 is a top view of a partial region of a liquid crystal display panel of the present invention;

FIGS. 3A-3C are cross-sectional views of schematic diagrams showing a manufacture process of a liquid crystal display panel of the present invention;

FIGS. 4A-4B are schematic diagrams showing positions of spacers not deviated or deviated from positions of scan lines and data lines of Comparative Example 1 respectively;

FIGS. 5A-5B are schematic diagrams showing positions of spacers not deviated or deviated from positions of scan lines and data lines of Example 1 respectively;

FIGS. 6A-6B are schematic diagrams showing positions of spacers not deviated or deviated from positions of scan lines and data lines of Comparative Example 2 respectively;

FIGS. 7A-7B are schematic diagrams showing positions of spacers not deviated or deviated from positions of scan lines and data lines of Example 2 respectively;

FIGS. 8A-8B are schematic diagrams showing positions of spacers not deviated or deviated from positions of scan lines and data lines of Example 3 respectively;

FIG. 9 is a schematic diagram showing a preferred embodiment of a group of spacers of the present invention;

FIG. 10 is a schematic diagram showing a preferred embodiment of a group of spacers of the present invention;

FIG. 11 is a schematic diagram showing a preferred embodiment of a group of spacers of the present invention; and

FIG. 12 is a cross-sectional view of a touch display device of the present invention.

### DETAILED DESCRIPTION OF THE PREFERRED EMBODIMENT

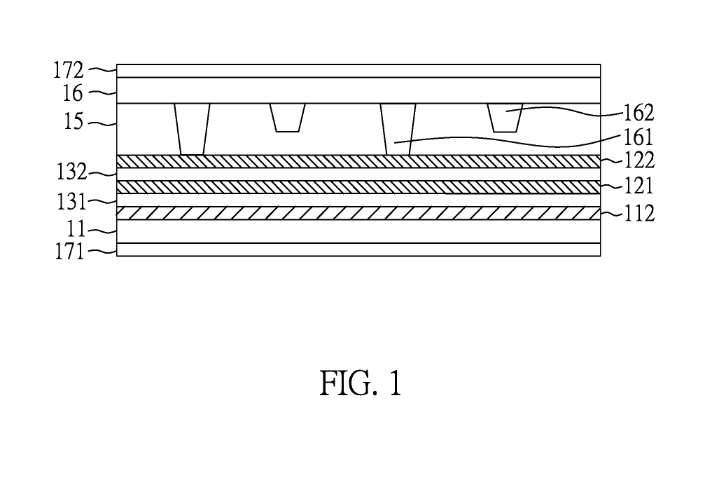

FIG. 1 is a cross-sectional view of a liquid crystal display panel of the examples and comparative examples of the present invention that will be described below. The liquid crystal display panel is a Fringe Field Switching (FFS) display panel, comprising: a first substrate 11; a second substrate 16; and a liquid crystal layer 15 disposed between the first substrate 11 and the second substrate 16. A polarizer 171 is disposed on an outer side of the first substrate 11 and a polarizer 172 is disposed on an outer side of the second substrate 16. A thin film transistor unit layer 112, a first insulating layer 131, a first electrode 121, a second insulating layer 132, and a second electrode 122 are sequentially disposed on the first substrate 11. The first electrode 121 is a common electrode layer and the second electrode 122 is a pixel electrode layer. The common electrode layer may be a plate electrode layer and the pixel electrode layer may be patterned with a fish-bone pattern or a zigzag pattern, but the present invention is not limited thereto.

In an embodiment of the present invention, the first substrate 11 and the second substrate 16 can be manufactured by using substrate materials such as glass, plastic, or flexible materials. The first electrode 121 and the second electrode 122 can be manufactured by using transparent conductive electrode materials such as ITO, IZO, or ITZO. The first insulating layer 131 and the second insulating layer 132 can be manufactured by using insulating layer materials such as oxides, nitrides, or nitrogen oxides. The polarizers 171, 172 can be linear polarizers, circular polarizers, and elliptical polarizers. Although not shown in FIG. 1, those of ordinary skills in the art should know that a backlight module (not shown) is disposed on an outer side of the polarizer 171 of the first substrate 11. In addition, an alignment layer (not shown) is disposed on the first substrate 11 and an alignment layer (not shown) is disposed on the second substrate 16, and the liquid crystal layer 15 is interposed in between.

As shown in FIG. 1, the liquid crystal display panel further comprises a plurality of main spacers 161 and a plurality of sub-spacers 162. The main spacers 161 and the sub-spacers 162 are manufactured by using spacer materials such as photoresist. The space between the first substrate 11 and the second substrate 16 as well as the thickness of the liquid crystal layer 15 can be defined by the main spacers 161. By disposing the main spacers 161 and the sub-spacers 162 with different heights, a process window for liquid crystal injection is provided.

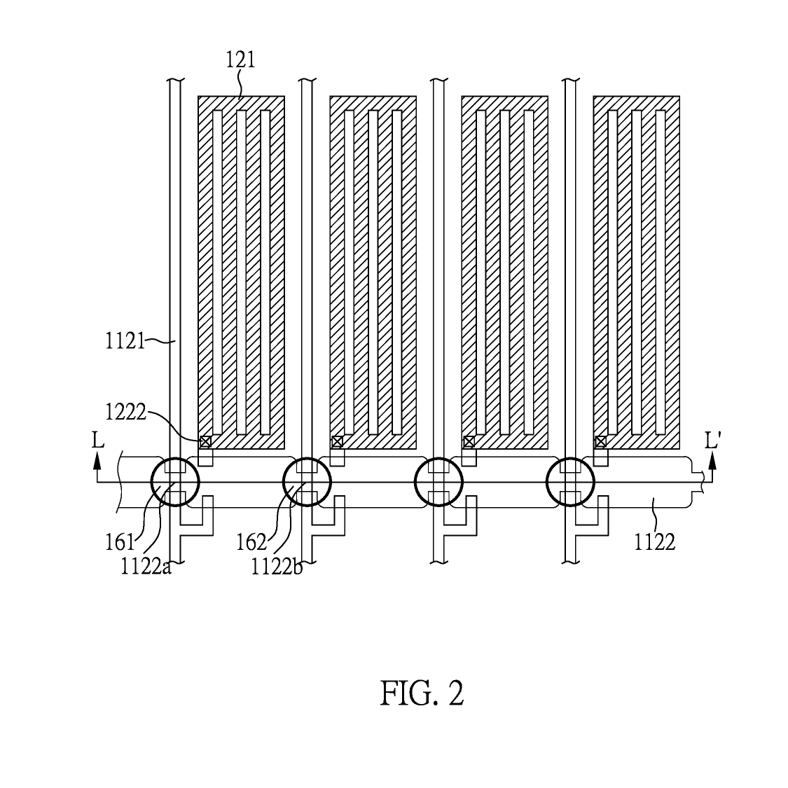

FIG. 2 is a top view of a partial region of a liquid crystal display panel of the examples and comparative examples of the present invention that will be described below. In the liquid crystal display panel, the first substrate 11 with a plurality of scan lines 1122 and a plurality of data lines 1121 disposed thereon, wherein the scan lines 1122 are substantially disposed in parallel, the data lines 1121 are substantially disposed in parallel, and the scan lines 1122 and the data lines 1121 intersect with each other and form a plurality of intersections, and the plurality of intersections comprise a plurality of first overlapping regions 1122a and a plurality of second overlapping regions 1122b. In the present example, not only the scan lines 1122 are substantially disposed in parallel and the data lines 1121 are substantially disposed in parallel, but the scan lines 1122 and the data lines 1121 are also substantially disposed perpendicularly forming the intersections. In addition, the second electrode 122 is electrically connected to the data line 1121 through a contact via 1222. The contact via 1222 is disposed outside the overlapping region of the scan line 1122 and the data line 1121 (outside the first overlapping region 1122a and the second overlapping region 1122b). Moreover, as shown in FIG. 2, the main spacers 161 are correspondingly disposed on the first overlapping regions 1122a. The sub-spacers 162 are correspondingly disposed on the second overlapping regions 1122b. In other words, the overlapping regions of the scan lines 1122 and the data lines 1121 where the main spacers 161 are correspondingly disposed (the first overlapping regions 1122a) are different from the overlapping regions of the scan lines 1122 and the data lines 1121 where the sub-spacers 162 are correspondingly disposed (the second overlapping regions 1122b). That is, each overlapping region of the scan lines 1122 and the data lines 1121 only comprises either one of the main spacers 161 or the sub-spacers 162. As shown in FIG. 2, the main spacers 161 and the sub-spacers 162 are correspondingly disposed on the first overlapping regions 1122a and the second overlapping regions 1122b respectively, but the present invention is not limited thereto. In other regions of the display panel of the present example or in other examples of the present invention, some of the overlapping regions of the scan lines 1122 and the data lines 1121 may not comprise the main spacers 161 and the sub-spacers 162. In other words, some of the first overlapping regions 1122a and/or the second overlapping regions 1122b may not comprise the main spacers 161 and/or the sub-spacers 162.

In the present example, the contact via 1222 is disposed outside the first overlapping region 1122a and the second overlapping region 1122b. In other words, the contact via 1222 is not disposed on the first overlapping region 1122a and the second overlapping region 1122b. The disposed positions of the main spacers 161 and the sub-spacers 162 are different from the disposed positions of the contact via 1222. When the disposed positions of the main spacers 161 and the sub-spacers 162 overlap with the disposed positions of the contact via 1222, the height difference is increased between the main spacers 161 and the oppositely-disposed substrate and between the sub-spacers 162 and the oppositely-disposed substrate. Since the disposed positions of the main spacers 161 and the sub-spacers 162 do not overlap with the disposed positions of the contact via 1222, the height difference is decreased between the main spacers 161 and the oppositely-disposed substrate and between the sub-spacers 162 and the oppositely-disposed substrate. The ripple effect caused by touching the liquid crystal display panel can then be reduced.

The scan lines 1122 and the data lines 1121 can be manufactured by using conductive materials such as metals, alloys, metal oxides, metal nitrogen oxides, or other electrode materials, but preferably metal materials.

In the present examples, comparative examples and other examples of the present invention, “substantially parallel” means the angle between two lines is 0° to 5°. “Substantially perpendicular” means the angle between two lines is 85° to 90°. “The overlapping region of the scan line and the data line” means the point of the intersection formed by the central line of the scan line and the central line of the data line. “The overlapping region of the scan line and the data line and the main spacer/sub-spacer are correspondingly disposed” means the point of the intersection formed by the central line of the scan line and the central line of the data line and the projected central point of the main spacer or the sub-spacer are correspondingly disposed. “The first overlapping region/the second overlapping region” preferably means the point of the intersection formed by the central line of the scan line and the central line of the data line. “The main spacer/sub-spacer and the first overlapping region/second overlapping region are correspondingly disposed” means the central point of the main spacer/sub-spacer and the point of intersection formed by the central line of the scan line and the central line of the data line are correspondingly disposed.

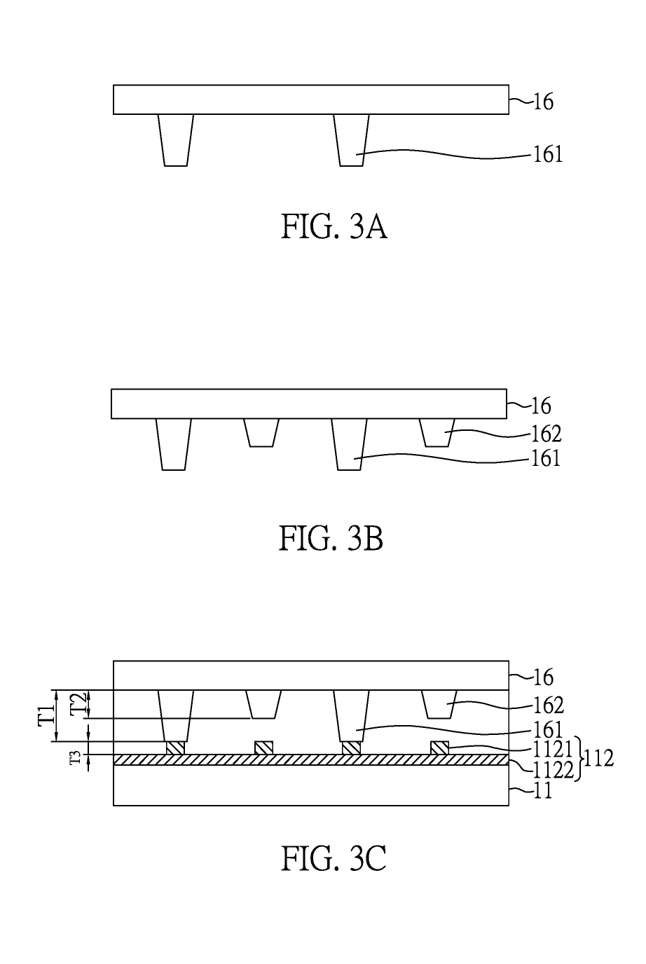

In an embodiment of the present invention, the main spacers 161 and the sub-spacers 162 are formed using photolithography. FIGS. 3A-3C are cross-sectional views of schematic diagrams showing a manufacture process of a liquid crystal display panel of the present invention. Specifically, FIGS. 3A-3C are cross-sectional views at the L-L′ cross-sectional line shown in FIG. 2. For clearer description, some layers of the liquid crystal display panel are omitted and not shown in FIGS. 3A-3C. As shown in FIG. 3A, a first photolithography is used to form the main spacers 161 on the second substrate 16. As shown in FIG. 3B, a second photolithography is used to form the sub-spacers 162 on the second substrate 16. As shown in FIG. 3C, liquid crystal molecules (not shown) are then injected on one of the first substrate 11 or the second substrate 16. The first substrate 11 and the second substrate 16 are correspondingly assembled to complete the manufacture of the liquid crystal display panel. In the present example, the main spacer 161 and the sub-spacer 162 are both disposed on the second substrate 16. However, in other examples of the present invention, the main spacer 161 and the sub-spacer 162 can both be formed on the first substrate 11. Or, one of the main spacer 161 and the sub-spacer 162 is formed on the first substrate 11 and the other is formed on the second substrate 16. A height (T1) of the main spacers 161 is greater than a height (T2) of the sub-spacers 162. The height (T1) of the main spacers 161 and the height (T2) of the sub-spacers 162 are not particularly limited. However, the height (T1) of the main spacers 161 is preferably between 1 μm and 5 μm. The height (T2) of the sub-spacers 162 is preferably between 1 μm and 5 μm. A difference between the heights (T1−T2) of the main spacers 161 and the sub-spacers 162 is 0.01 μm to 4 μm. In other embodiments of the present invention, a difference between the heights (T1−T2) of the main spacers 161 and the sub-spacers 162 is 0.01 μm to 1 μm.

Ideally, as shown in FIGS. 2 and 3C, the intervals between the main spacers 161 and the sub-spacers 162 are the same. Moreover, the positions of the main spacers 161 and the sub-spacers 162 overlap with the overlapping regions of the scan lines 1122 and data lines 1121 without any deviations. However, since the main spacers 161 and the sub-spacers 162 are formed using two different photolithographies; deviations might occur between the two different photolithographies as shown in FIGS. 3A-3C. After the substrates are correspondingly assembled, the thickness of the liquid crystal layer defined by the main spacers 161 and the sub-spacers 162 will differ from the predetermined thickness. The liquid crystal display quality will then be affected.

The relative positions between the main spacers 161 and the sub-spacers 162 and the scan lines 1122 and the data lines 1211 of the examples and comparative examples of the present invention will be described.

It should be noted in the examples and comparative examples of the present invention described below, the relative positions between the main/sub-spacers and the first/second overlapping regions can be defined by vectors of the main/sub-spacers from the first/second overlapping regions. “The vectors of the main/sub-spacers from the first/second overlapping regions” means the direction and length from the first/second overlapping regions to the main/sub-spacers. As a result, adjustment of vectors of the main/sub-spacers from the first/second overlapping regions means adjustment of the direction and/or length from the first/second overlapping regions to the main/sub-spacers.

### Comparative Example 1

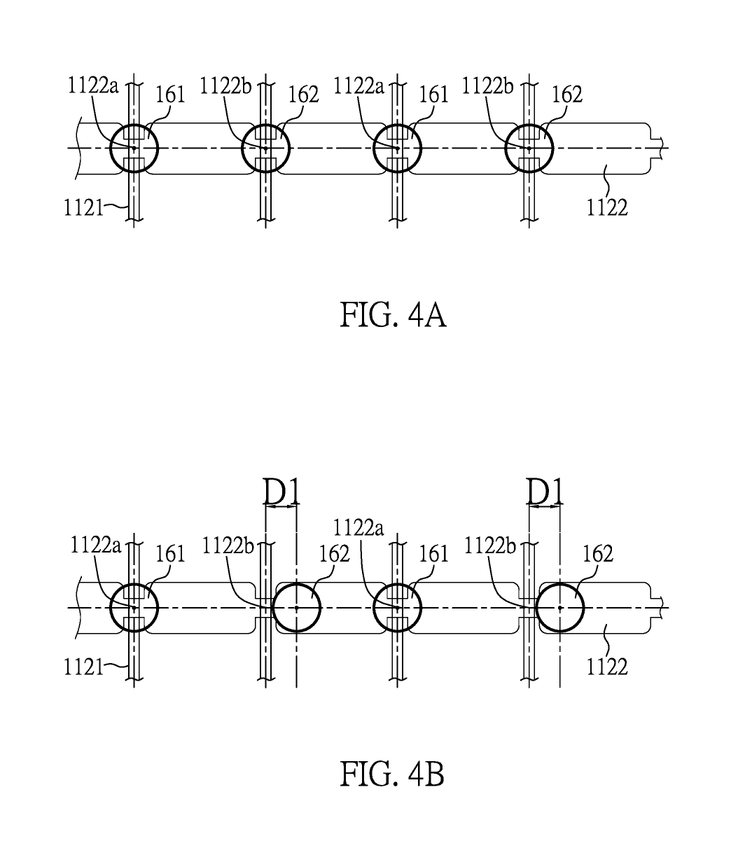

FIGS. 4A-4B are schematic diagrams showing positions of spacers not deviated or deviated from positions of scan lines and data lines of a liquid crystal display panel respectively. The arrangement of the scan lines, the data lines, the main spacers, and the sub-spacers are the same as shown in FIG. 2, except some units shown in FIG. 2 are omitted for clearer description.

As shown in FIG. 4A, the first overlapping regions 1122a and the main spacers 161 are correspondingly disposed. The second overlapping regions 1122b and the sub-spacers 162 are correspondingly disposed. The relative positions between the first overlapping regions 1122a and the main spacers 161 are the same. The relative positions between the second overlapping regions 1122b and the sub-spacers 162 are the same. In other words, the relative positions between the main spacers 161 and its closest first overlapping region 1122a are the same, and the relative positions between the sub-spacers 162 and its closest second overlapping region 1122b are the same. More specifically, each of the first overlapping regions 1122a forms a first vector to each of the main spacers 161, and each of the second overlapping regions 1122b forms a second vector to each of the sub-spacers 162. The first vectors are the same, and the second vectors are the same. The points of the intersections formed by the central lines (represented by dashed lines) of the scan lines 1122 and the data lines 1121, and the projected central points (represented by points) of the main spacers 161 and the sub-spacers 162 overlap.

FIG. 4B shows the case when deviation occurs during the manufacture of the sub-spacers 162. As shown in FIG. 4B, the points of the intersections formed by the central lines (represented by dashed lines) of the scan lines 1122 and the data lines 1121 (the first overlapping regions 1122a), and the projected central points (represented by points) of the main spacers 161 overlap. However, the points of the intersections formed by the central lines (represented by dashed lines) of the scan lines 1122 and the data lines 1121 (the second overlapping regions 1122b), and the projected central points (represented by points) of the sub-spacers 162 do not overlap and having a deviation D1. When no deviation occurs during the manufacture of the sub-spacers 162 (as shown in FIGS. 3C and 4A), the process window for liquid crystal injection by One Drop Filling (ODF) method will be the height difference (T1−T2) between the main spacers 161 and the sub-spacers 162. When deviation occurs during the manufacture of the sub-spacers 162 (as shown in FIGS. 3C and 4B), the process window not only includes the height difference between the main spacers 161 and the sub-spacers 162, but also includes the thickness (T3) of the data line 1121 on the second overlapping regions 1122b. In this case, the total process window is (T1−T2)+T3. Comparing to no deviation in manufacture as shown in FIG. 4A, the deviation in manufacture as shown in FIG. 4B will cause the process window to increase. As a result, the amount of liquid crystals will increase and the ripple effect occurs more easily by touching the display panel.

To overcome the problem shown in FIG. 4B, in a preferred example of the present invention, by adjusting the relative positions of the sub-spacers and the second overlapping regions (by adjusting the second vectors of different sub-spacers from the second overlapping regions), the ripple effect caused by touching the display panel is reduced.

### Example 1

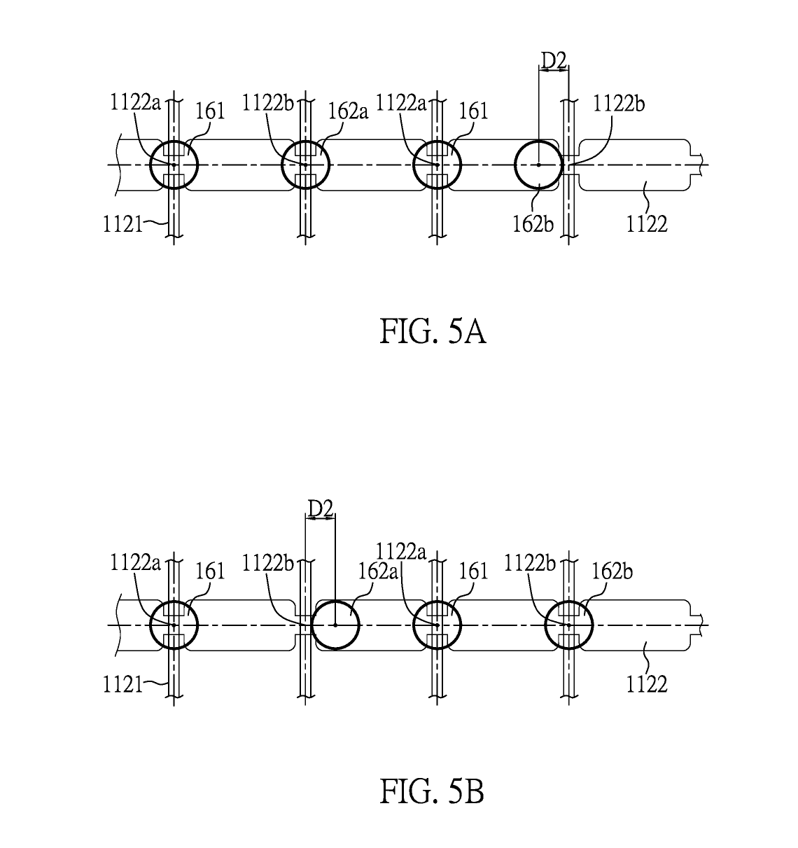

FIGS. 5A-5B are schematic diagrams showing positions of spacers not deviated or deviated from positions of scan lines and data lines of a liquid crystal display panel respectively. In the present example, the relative positions of the sub-spacers and the second overlapping regions are adjusted (the second vectors of different sub-spacers from the second overlapping regions are adjusted). Since the positions of the main spacers are not changed (same as shown in FIGS. 4A and 4B), there is no further description herein.

FIG. 5A shows the case when no deviation occurs during the manufacture of first sub-spacers 162a and second sub-spacers 162b. In this case, each of the second overlapping regions 1122b forms a fourth vector to each of the closest sub-spacers 162. The fourth vector of the first sub-spacer 162a and the fourth vector of the second sub-spacer 162b formed from the closest second overlapping regions 1122b are designed to be different. More specifically, the positions of the projected central points (represented by points) of the first sub-spacer 162a and the second sub-spacer 162b are different from the positions of the points of the intersections formed by the central lines (represented by dashed lines) of the scan lines 1122 and the data lines 1121. In the present example, the first sub-spacer 162a and the second overlapping region 1122b overlap, and there is a distance D2 between the second sub-spacer 162b and the closest second overlapping region 1122b. More specifically, the projected central point (represented by point) of the first sub-spacer 162a and the point of the intersection formed by the central lines (represented by dashed lines) of the scan line 1122 and the data line 1121 overlap. There is a distance D2 between the projected central point (represented by point) of the second sub-spacer 162b and the point of the intersection formed by the central lines (represented by dashed lines) of the scan line 1122 and the data line 1121. As shown in FIGS. 3C and 5A, since the first sub-spacer 162a still overlaps with the second overlapping region 1122b, the process window is still the height difference (T1−T2) between the main spacers 161 and the first sub-spacers 162a.

FIG. 5B shows the case when deviation occurs during the manufacture of the first sub-spacer 162a and the second sub-spacer 162b. In this case, the second sub-spacer 162b and the second overlapping region 1122b overlap, and there is a distance D2 between the first sub-spacer 162a and the correspondingly disposed second overlapping region 1122b. More specifically, the projected central point (represented by point) of the second sub-spacer 162b and the point of the intersection formed by the central lines (represented by dashed lines) of the scan line 1122 and the data line 1121 overlap. There is a distance D2 between the projected central point (represented by point) of the first sub-spacer 162a and the point of the intersection formed by the central lines (represented by dashed lines) of the scan line 1122 and the data line 1121. As shown in FIGS. 3C and 5B, since the second sub-spacer 162b still overlaps with the second overlapping region 1122b, the process window is still the height difference (T1−T2) of the main spacers 161 and the second sub-spacers 162b. Hence, by designing the relative positions between the first sub-spacers 162a and the correspondingly disposed second overlapping regions 1122b, and between the second sub-spacers 162b and the correspondingly disposed second overlapping regions 1122b as described above, the process window will remain the same in the display panel whether the deviation occurs or not during the manufacture of the sub-spacers. As a result, the amount of liquid crystals of the panels shown in FIGS. 5A and 5B will not change. Without designing the positions of the sub-spacers for the display panel as shown in FIG. 4B, the process window will increase due to deviations during the manufacture of the sub-spacers and results in increasing amount of liquid crystals. Since the process windows of the panels shown in FIGS. 5A and 5B are smaller than the process window of the panel shown in FIG. 4B, the amount of liquid crystals are reduced and the rigidities of the panels are improved. The ripple effects caused by touching the panels shown in FIGS. 5A and 5B are reduced as well.

In the present example, range of the distance D2 is not particularly limited and may be between 2 μm and 10 μm.

### Comparative Example 2

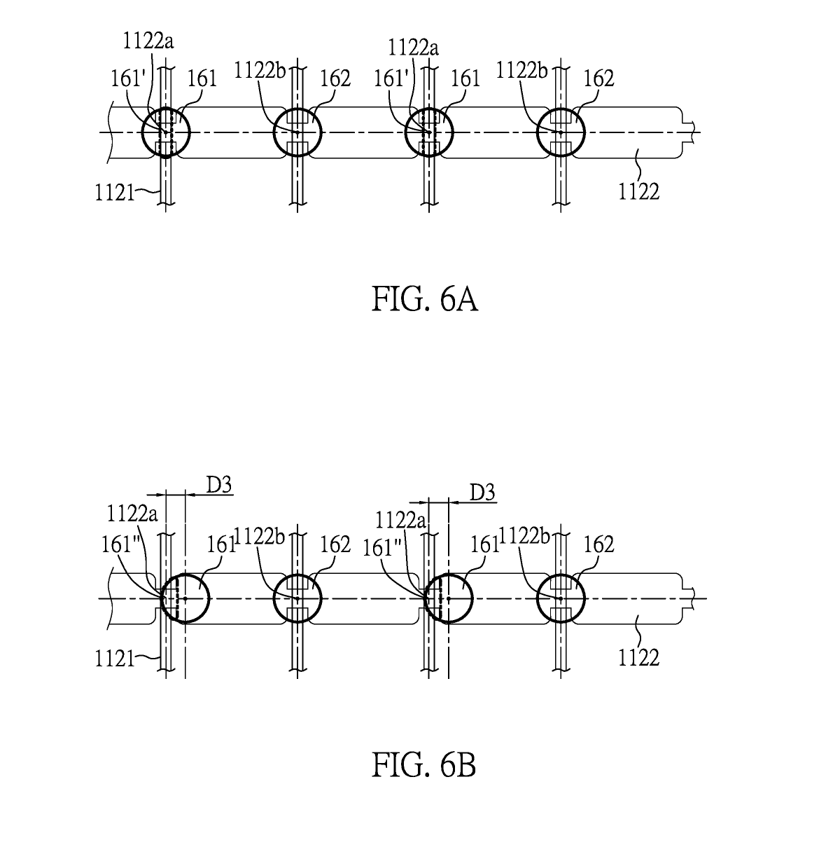

FIGS. 6A-6B are schematic diagrams showing positions of spacers not deviated or deviated from positions of scan lines and data lines of a liquid crystal display panel respectively. The arrangement of the scan lines, the data lines, the main spacers, and the sub-spacers are the same as shown in FIG. 2, except some units shown in FIG. 2 are omitted for clearer description.

As shown in FIG. 6A, the positions of the main spacers 161 and the sub-spacers 162 are the same as shown in FIG. 4A and there is no further description herein. However, it should be noted that the main spacer 161 and the first overlapping region 1122a comprise an overlapping region 161′.

FIG. 6B shows the case when deviation occurs during the manufacture of the main spacers 161. As shown in FIG. 6B, the points of the intersections formed by the central lines (represented by dashed lines) of the scan lines 1122 and the data lines 1121, and the projected central points (represented by points) of the sub-spacers 162 overlap. However, the points of the intersections formed by the central lines (represented by dashed lines) of the scan lines 1122 and the data lines 1121, and the projected central points (represented by points) of the main spacers 161 do not overlap and having a deviation D3. The overlapping regions 161″ with deviation (as shown in FIG. 6B) and the overlapping regions 161′ without deviation (as shown in FIG. 6A) are different. More specifically, since the sizes of the overlapping regions 161′ (as shown in FIG. 6A) and the sizes of the overlapping regions 161″ (as shown in FIG. 6B) are different, the compression areas and compression ratios of the main spacers 161 shown in FIGS. 6A and 6B are different as well. Different compression area and compression ratio causing the ripple effect occurs more easily by touching the display panel.

To overcome the problem shown in FIG. 6B, in a preferred example of the present invention, the first vectors of the main spacers from the first overlapping regions of the display panel are adjusted to reduce the ripple effect caused by touching the display panel.

### Example 2

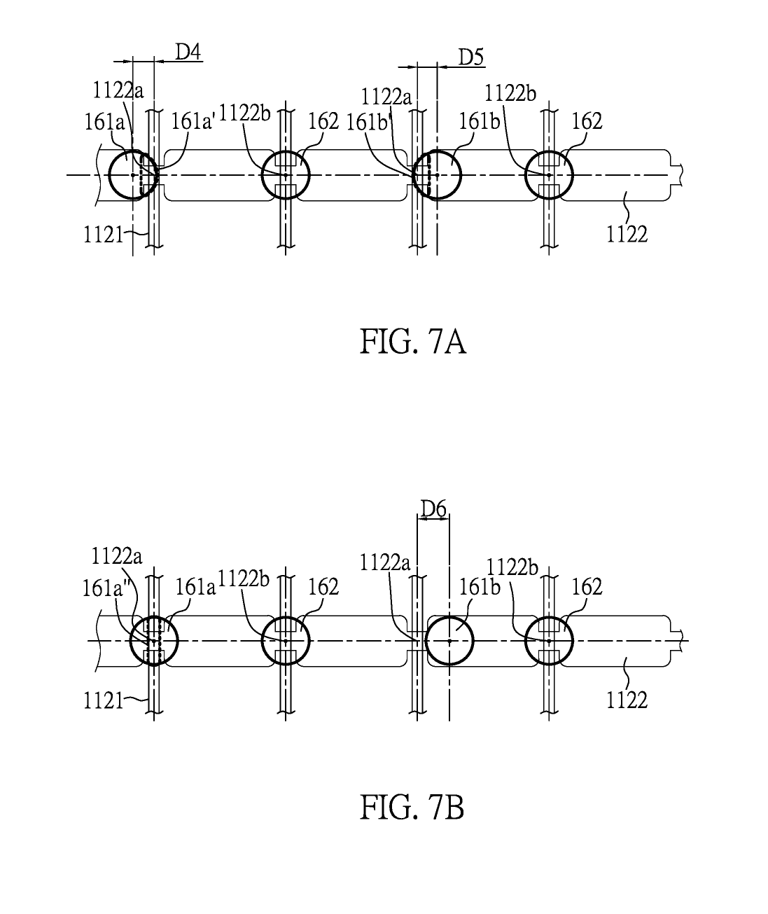

FIGS. 7A-7B are schematic diagrams showing positions of spacers not deviated or deviated from positions of scan lines and data lines of a liquid crystal display panel respectively. In the present example, vectors of the main spacers from the first overlapping regions of a display panel are adjusted. Since the positions of the sub-spacers are not changed (same as shown in FIGS. 6A and 6B), there is no further description herein.

FIG. 7A shows the case when no deviation occurs during the manufacture of first main spacers 161a and second main spacers 161b. In this case, each of the first overlapping regions 1122a forms a third vector to each of the closest main spacers 161. The third vector of the first main spacer 161a and the third vector of the second main spacer 161b formed from the closest first overlapping regions 1122a are designed to be different. More specifically, the positions of the projected central points (represented by points) of the first main spacer 161a and the second main spacer 161b are different from the positions of the points of the intersections formed by the central lines (represented by dashed lines) of the scan lines 1122 and the data lines 1121. In the present example, there is a distance D4 between the first main spacer 161a and the correspondingly disposed first overlapping region 1122a. More specifically, there is a distance D4 between the projected central point (represented by point) of the first main spacer 161a and the point of the intersection formed by the central lines (represented by dashed lines) of the scan line 1122 and the data line 1121, which forms an overlapping region 161a′. There is a distance D5 between the second main spacer 161b and the correspondingly disposed first overlapping region 1122a. More specifically, there is a distance D5 between the projected central point (represented by point) of the second main spacer 161b and the point of the intersection formed by the central lines (represented by dashed lines) of the scan line 1122 and the data line 1121, which forms an overlapping region 161b′.

FIG. 7B shows the case when deviation occurs during the manufacture of the first main spacer 161a and the second main spacer 161b. In this case, the first main spacer 161a and the first overlapping region 1122a overlap, which forms an overlapping region 161a″. There is a distance D6 between the second main spacer 161b and the correspondingly disposed first overlapping region 1122a. More specifically, there is a distance D6 between the projected central point (represented by point) of the second main spacer 161b and the point of the intersection formed by the central lines (represented by dashed lines) of the scan line 1122 and the data line 1121. In the present example, the sum of the areas of the corresponded overlapping region 161a′ of the first main spacer 161a and the areas of the corresponded overlapping region 161b′ of the second main spacer 161b (as shown in FIG. 7A) is designed to be the same as the area of the corresponded overlapping region 161a″ of the first main spacer 161a (as shown in FIG. 7B). Consequently, the total compression area and the total compression ratio of the first main spacer 161a and the second main spacer 161b will be constant. The ripple effect caused by touching the display panel can then be reduced.

In the present example, range of the distances D4, D5, D6 are not particularly limited and may be between 2 μm and 10 μm.

### Example 3

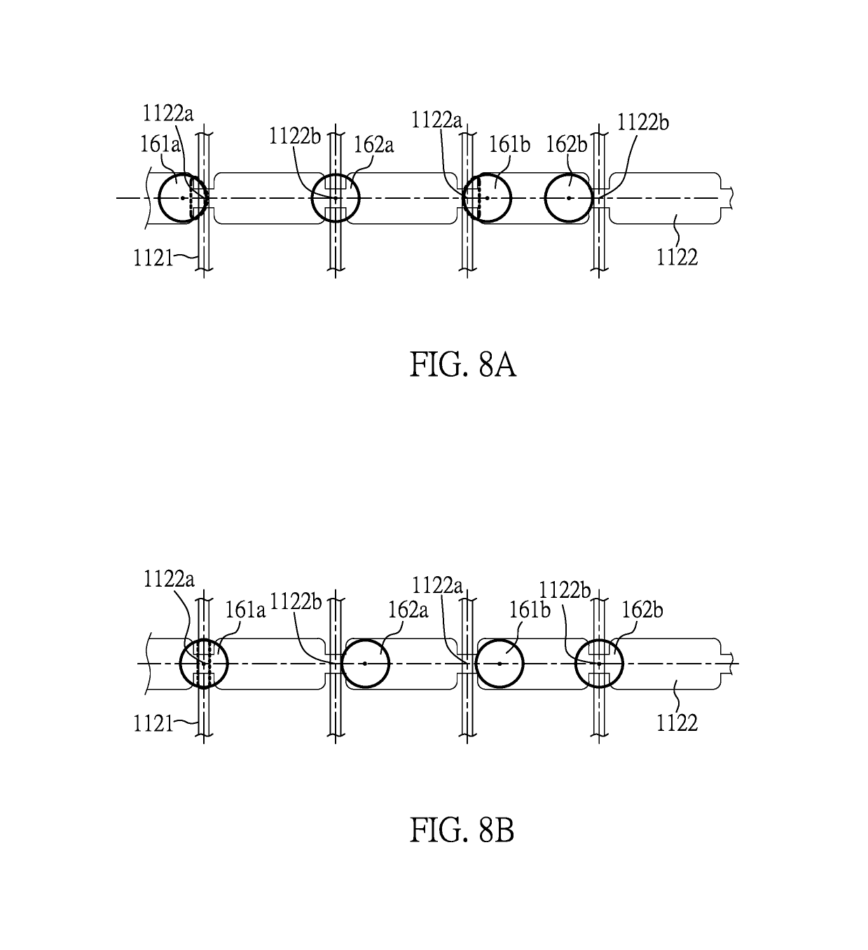

FIGS. 8A-8B are schematic diagrams showing positions of spacers not deviated or deviated from positions of scan lines and data lines of a liquid crystal display panel respectively. In the present example, both vectors of the main spacers from the first overlapping regions and vectors of the sub-spacers from the second overlapping regions of a display panel are adjusted. Since the adjustment of the main spacers is the same as Example 2 and the adjustment of the sub-spacers is the same as Example 1, there is no further description herein.

In the examples of the present invention described above, the relative positions of the main spacers and the first overlapping regions, and the relative positions of the sub-spacers and the second overlapping regions are adjusted along the lengthwise direction of the scan lines. However, in other examples of the present invention, the adjustments of the relative positions of the main spacers and the first overlapping regions, and the relative positions of the sub-spacers and the second overlapping regions are not limited along the lengthwise direction of the scan lines. The adjustments can be along the lengthwise direction of the data lines or along any directions, as long as the adjustment of the main spacers are the same as Example 2 and the adjustment of the sub-spacers are the same as Example 1, the ripple effect caused by touching the display panel can be reduced. “Changes along any directions” means the connected line between the projected central points (represented by points) of the main spacers and the sub-spacers and points of the intersections formed by the central lines (represented by dashed lines) of the data lines and the scan lines forms an angle between the lengthwise direction of the scan line, and the angle is not limited to 0° and can be between 0° and 180°.

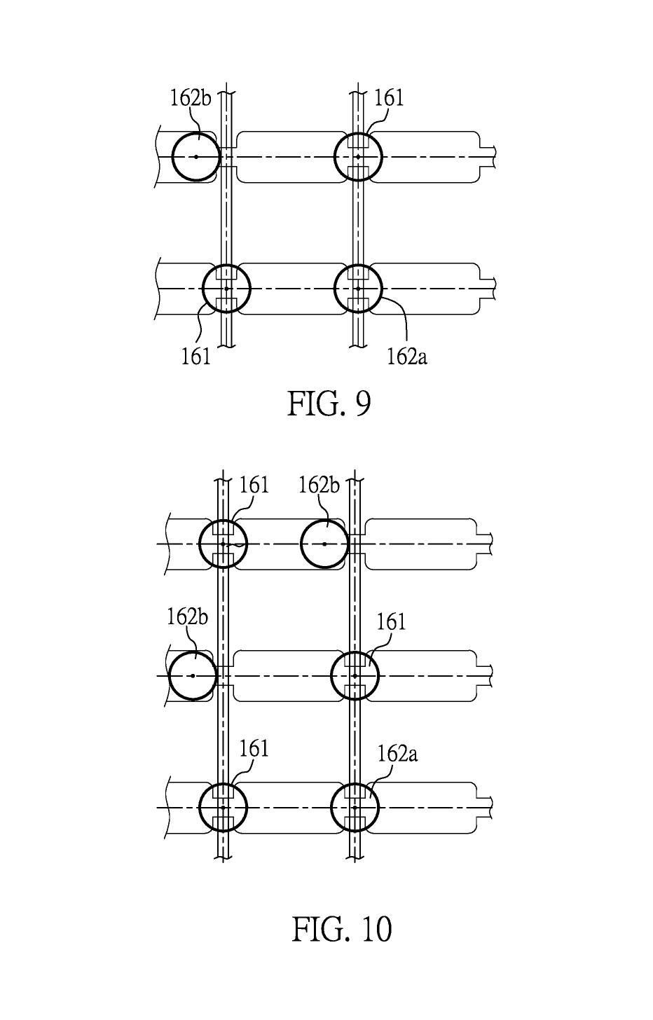

The above-mentioned examples of the present invention are described using a staggered arrangement of two main spacers and two sub-spacers in a 1×4 row. However, in other examples of the present invention, groups of main spacers and sub-spacers can be different depending on requirements. For example, as shown in FIG. 9, a group of spacers of an embodiment of the present invention can be two main spacers and two sub-spacers arranged in a 2×2 array. Or, as shown in FIG. 10, a group of spacers of an embodiment of the present invention can be three main spacers and three sub-spacers arranged in a 2×3 array. However, the groups of spacers for the present invention are not limited to the groups of spacers shown in FIGS. 9 and 10 and can be arranged in other arrays.

Although FIGS. 9 and 10 show the cases when the positions of the sub-spacers are deviated in Example 1; however, FIGS. 9 and 10 can also show the cases when the positions of the main spacers and/or the sub-spacers are deviated in Examples 1, 2, and 3. FIGS. 9 and 10 only show the relationships among the spacers. The sizes of the pixel electrodes of the present invention are not limited to the proportions shown in FIGS. 9 and 10.

In the aforementioned examples of the present invention, among the groups of spacers divided by the main spacers and the sub-spacers, all groups of spacers comprise same numbers of main spacers and sub-spacers. For example, as shown in FIG. 9, the group of spacer comprises two main spacers and two sub-spacers. However, in other examples of the present invention, the groups of spacers can comprise different numbers of main spacers and sub-spacers.

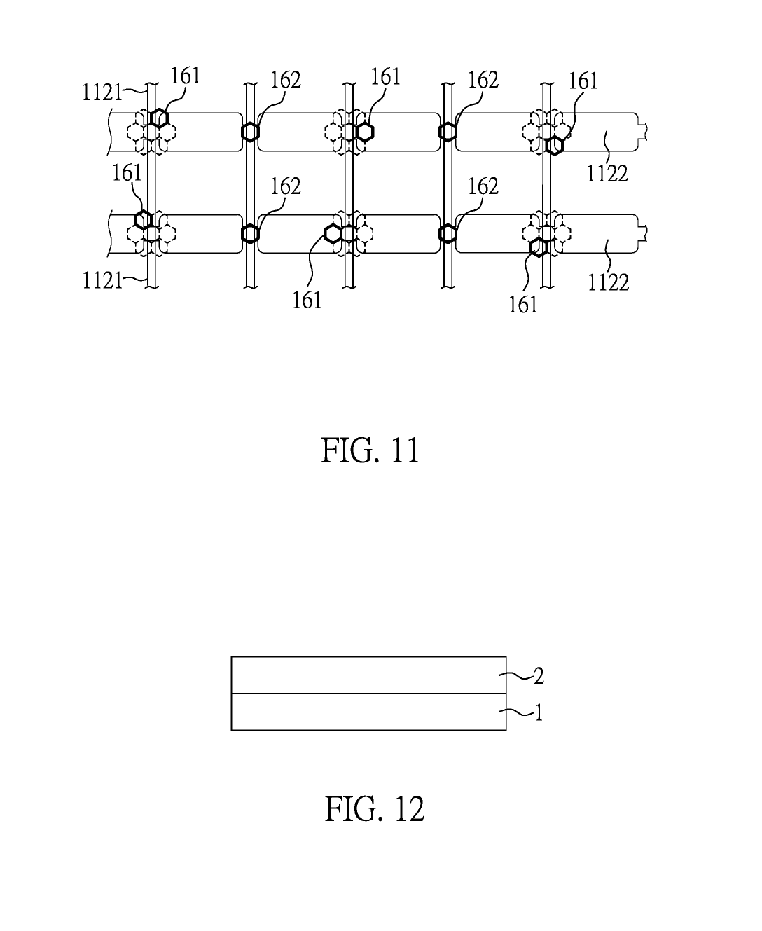

For example, FIG. 11 is a top view of a liquid crystal display panel of the present invention. As shown in FIG. 11, the group of spacers comprises six main spacers and four sub-spacers arranged in a 5×2 array. The main spacers can be arranged in a regular pattern with a plum blossom design. For example, the main spacers can be disposed at the positions shown by the solid lines or at any positions shown by the dashed lines. However, in other examples of the present invention, not only the main spacers can be arranged with a plum blossom design, but the sub-spacers can also be arranged with a plum blossom design. In other words, both or either the main spacers or the sub-spacers can be arranged with a plum blossom design. In the present example, the arrangement with a plum blossom design is only a demonstration. However, in other examples of the present invention, the arrangement is not limited to a plum blossom design. The arrangement can be other designs and can also be arranged irregularly.

The numbers of the main spacers and the sub-spacers as well as the positions where the main spacers and the sub-spacers are disposed in the aforementioned embodiments of the present invention are only examples, but not limited thereto. The numbers of the main spacers and the sub-spacers as well as the positions where the main spacers and the sub-spacers are disposed in the present invention can be adjusted according to requirements, as long as the adjustment of the main spacers is the same as Example 2 and the adjustment of the sub-spacers is the same as Example 1, the ripple effect caused by touching a liquid crystal display panel can then be reduced.

The display devices manufactured by the aforesaid examples of the present invention can be used with a touch panel as a touch display device. As shown in FIG. 12, a touch display device of an embodiment of the present invention comprises: a display panel 1 as described above; and a touch panel 2 disposed on the display panel 1.

The display panels and the touch display devices manufactured by the aforementioned examples of the present invention can be used in any electronic devices requiring display screens such as displays, mobile phones, laptop computers, video cameras, cameras, music players, mobile navigation devices, and televisions.

Although the present invention has been explained in relation to its preferred embodiment, it is to be understood that many other possible modifications and variations can be made without departing from the spirit and scope of the invention as hereinafter claimed.

What is claimed is:

1. A display panel, comprising:
a first substrate with a plurality of scan lines and a plurality of data lines disposed thereon, wherein the scan lines are substantially disposed in parallel, the data lines are substantially disposed in parallel, the scan lines and the data lines intersect with each other and form a plurality of intersections, and the plurality of intersections comprise a plurality of first overlapping regions and a plurality of second overlapping regions;
a plurality of main spacers correspondingly disposed on part of the first overlapping regions, wherein each of the part of the first overlapping regions forms a first vector to each of the plurality of main spacers; and
a plurality of sub-spacers correspondingly disposed on part of the second overlapping regions, wherein each of the part of the second overlapping regions forms a second vector to each of the plurality of sub-spacers;
wherein at least two of the first vectors are different, and at least two of the second vectors are different.

2. The display panel according to claim 1, wherein each of the part of the first overlapping regions forms a third vector to each of the closest main spacer, each of the part of the second overlapping regions forms a fourth vector to each of the closest sub-spacer, and at least two of the third vectors are different and at least two of the fourth vectors are different.

3. The display panel according to claim 1, wherein a height of the main spacers is greater than a height of the sub-spacers.

4. The display panel according to claim 1, wherein a difference between heights of the main spacers and the sub-spacers is 0.01 μm to 4 μm.

5. The display panel according to claim 1, wherein when at least two of the first vectors are different, the main spacers comprise a first main spacer and a second main spacer, wherein the first main spacer overlaps with the first overlapping region, and the second main spacer is at a distance from the first overlapping region that the second main spacer is correspondingly disposed.

6. The display panel according to claim 1, wherein when at least two of the second vectors are different, the sub-spacers comprise a first sub-spacer and a second sub-spacer, wherein the first sub-spacer overlaps with the second overlapping region, and the second sub-spacer is at a distance from the second overlapping region that the second sub-spacer is correspondingly disposed.

7. The display panel according to claim 1, further comprising a second substrate and a liquid crystal layer, wherein the liquid crystal layer is disposed between the first substrate and the second substrate.

8. The display panel according to claim 7, wherein the main spacers and the sub-spacers are respectively disposed on the first substrate or the second substrate.

9. The display panel according to claim 8, wherein the main spacers and the sub-spacers are both disposed on the first substrate or the second substrate.

10. A touch display device, comprising:
a display panel, comprising:
a first substrate with a plurality of scan lines and a plurality of data lines disposed thereon, wherein the scan lines are substantially disposed in parallel, the data lines are substantially disposed in parallel, the scan lines and the data lines intersect with each other and form a plurality of intersections, and the plurality of intersections comprise a plurality of first overlapping regions and a plurality of second overlapping regions;
a plurality of main spacers correspondingly disposed on part of the first overlapping regions, wherein each of the part of the first overlapping regions forms a first vector to each of the plurality of main spacers; and
a plurality of sub-spacers correspondingly disposed on part of the second overlapping regions, wherein each of the part of the second overlapping regions forms a second vector to each of the plurality of sub-spacers;
wherein at least two of the first vectors are different, and at least two of the second vectors are different; and
a touch panel disposed on the display panel.

11. The touch display device according to claim 10, wherein each of the part of the first overlapping regions forms a third vector to each of the closest main spacer, each of the part of the second overlapping regions forms a fourth vector to each of the closest sub-spacer, and at least two of the third vectors are different and at least two of the fourth vectors are different.

12. The touch display device according to claim 10, wherein a height of the main spacers is greater than a height of the sub-spacers.

13. The touch display device according to claim 10, wherein a difference between heights of the main spacers and the sub-spacers is 0.01 μm to 4 μm.

14. The touch display device according to claim 10, wherein when at least two of the first vectors are different, the main spacers comprise a first main spacer and a second main spacer, wherein the first main spacer overlaps with the first overlapping region, and the second main spacer is at a distance from the first overlapping region that the second main spacer is correspondingly disposed.

15. The touch display device according to claim 10, wherein when at least two of the second vectors are different, the sub-spacers comprise a first sub-spacer and a second sub-spacer, wherein the first sub-spacer overlaps with the second overlapping region, and the second sub-spacer is at a distance from the second overlapping region that the second sub-spacer is correspondingly disposed.

16. The touch display device according to claim 10, wherein the display panel further comprises a second substrate and a liquid crystal layer, and the liquid crystal layer is disposed between the first substrate and the second substrate.

17. The touch display device according to claim 16, wherein the main spacers and the sub-spacers are respectively disposed on the first substrate or the second substrate.

18. The touch display device according to claim 17, wherein the main spacers and the sub-spacers are both disposed on the first substrate or the second substrate.
